(19) United States
(12) Patent Application Publication
(10) Pub. No.: US 2025/0075806 A1
(43) Pub. Date: Mar. 6, 2025

(54) VALVE

(71) Applicant: Critical Component LLC, Roanoke, AL (US)

(72) Inventors: Aaron Parker, Nashville, TN (US); Coty Yarbrough, Roanoke, AL (US)

(21) Appl. No.: 18/779,973

(22) Filed: Jul. 22, 2024

Related U.S. Application Data
(60) Provisional application No. 63/579,341, filed on Aug. 29, 2023.

(51) Int. Cl. F16K 5/06; F16K 5/12

(52) U.S. Cl. CPC F16K 5/0605; F16K 5/0647; F16K 5/12

(57) ABSTRACT

Various implementations include a valve having a body, a diffuser, and a ball. The body defines a cavity and inlet and outlet ports extending to the cavity. A first diffuser end defines a diffuser central channel extending to a second diffuser end. The diffuser insert is disposed within the cavity such that the second diffuser end is adjacent the outlet port. The ball outer surface defines a groove extending circumferentially along a center line at least partially around a circumference of the ball. The groove has a V-shaped profile in a plane perpendicular to the center line. A depth of the groove tapers along the centerline from a shallowest groove portion to a deepest groove portion. The ball is rotatably disposed within the cavity such that the ball is adjacent the first diffuser end and the inlet port.

### BACKGROUND

Metering ball valves are flow control devices for controlling the flow of fluid through a fluid conduit. Many ball valves include a ball with an opening passing from a first side to a diametrically opposed second side. As the ball is rotated within the valve body, the opening of the ball becomes increasingly more in fluid communication with the inlet and outlet of the valve body to increase/decrease the amount of fluid passing from the valve body inlet, through the opening of the ball, and out of the valve body outlet. Although these valves allow for high flow rates, rotation of the ball of these types of valves does not cause a proportionate, linear increase/decrease in fluid flow rate through the valve. Thus, these valves suffer from poor metering control.

### SUMMARY

Various implementations include a valve having a body, a diffuser, and a ball. The body has a first body end and a second body end opposite and spaced apart from the first body end. The body defines a cavity. The first body end defines an inlet port extending to the cavity, and the second body end defines an outlet port extending to the cavity. The diffuser insert has a diffuser longitudinal axis, a first diffuser end, and a second diffuser end opposite and spaced apart from the first diffuser end. The first diffuser end defines a diffuser central channel extending to the second diffuser end. The diffuser insert is disposed within the cavity such that the second diffuser end is adjacent the outlet port and the diffuser central channel is in fluid communication with the cavity and the outlet port. The ball has a ball outer surface. The ball outer surface defines a groove extending circumferentially along a center line at least partially around a circumference of the ball. The groove has a V-shaped profile in a plane perpendicular to the center line. A depth of the groove tapers along the centerline from a shallowest groove portion to a deepest groove portion. The ball is rotatably disposed within the cavity such that the ball is adjacent the first diffuser end and the inlet port.

In some implementations, the ball is rotatable between a first position, a second position, and a third position. In some implementations, the inlet port is not in fluid communication with the groove in the first position. In some implementations, the inlet port is in fluid communication with the shallowest groove portion in the second position. In some implementations, the inlet port is in fluid communication with the deepest groove portion in the third position.

In some implementations, the diffuser central channel is defined by a diffuser inner surface. In some implementations, the diffuser inner surface defines one or more longitudinally extending diffuser grooves extending from the first diffuser end toward the second diffuser end. In some implementations, the first diffuser end defines a diffuser seal groove. In some implementations, the valve further includes a diffuser seal disposed in the diffuser seal groove. In some implementations, the ball abuts the diffuser seal.

In some implementations, the valve further includes a valve stem coupled to the ball and rotatable relative to the body. In some implementations, rotation of valve stem causes the ball to rotate. In some implementations, the valve further includes a handle coupled to the valve stem for causing rotation of the valve stem. In some implementations, the valve further includes an actuator coupled to the valve stem for causing rotation of the valve stem.

In some implementations, the valve further includes a dial gauge adjacent the valve stem. In some implementations, the dial gauge includes a scale of amounts of fluid flowing through the valve.

In some implementations, the valve is a 1-inch valve.

In some implementations, the valve is a soft wash valve for metering bleach into a stream of water.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1 is a perspective view of a valve, according to one implementation.

FIG. 2 is a cross-sectional view of the valve of FIG. 1 along section line 2-2.

FIG. 3 is a perspective view of the ball, valve stem, and handle of the valve of FIG. 1.

FIG. 4 is a right side view of the ball of the valve of FIG. 1.

FIG. 5 is a left side view of the ball of the valve of FIG. 1.

FIG. 6 is a perspective view of the ball, ball seal, diffuser insert, and diffuser seal of the valve of FIG. 1.

FIG. 7 is a perspective view of the diffuser insert, diffuser seal, and O-ring of the valve of FIG. 1.

FIG. 8 is a rear perspective view of the diffuser insert of the valve of FIG. 1.

FIG. 9 is a front perspective view of the diffuser insert of the valve of FIG. 1.

FIG. 10A is a perspective view of the ball of the valve of FIG. 1.

FIG. 10B is a left side view of the ball of the valve of FIG. 1.

FIG. 10C is a top view of the ball of the valve of FIG. 1.

FIG. 10D is a cross-sectional view of the ball of the valve of FIG. 1 along line A-A.

FIG. 11A is a perspective view of the diffuser insert of the valve of FIG. 1.

FIG. 11B is an end view of the diffuser insert of the valve of FIG. 1.

FIG. 11C is a cross-sectional view of the diffuser insert of the valve of FIG. 1 along line B-B.

FIG. 12 is a valve flow coefficient (Cv) chart for the valve of FIG. 1.

### DETAILED DESCRIPTION

The devices, systems, and methods disclosed herein provide for metering ball valves for use in soft washing systems that allow for high flow rates and superior metering. The valve includes a ball that has a circumferentially extending, V-shaped groove. The V-shaped groove increases in depth from one end of the groove to the other end of the groove. The V-shaped groove allows for superior metering capability over existing ball valves.

The valve further includes a diffuser insert defining a diffuser central channel. The inner surface of the diffuser central channel defines one or more longitudinally extending diffuser grooves in fluid communication with V-shaped groove of the ball. The diffuser grooves allow for higher flow rates through the valve than with other types of metering valves.

The valves disclosed herein are soft wash valves for metering bleach, soap, or other fluid into a stream of water. The valve is designed to be located in the suction side of the pump such that fluid is drawn through the valve. However, it should be understood by those having ordinary skill in the art that the valve can be used in many other applications in which metering of fluid is desired and at any location along a fluid flow path.

Various implementations include a valve having a body, a diffuser, and a ball. The body has a first body end and a second body end opposite and spaced apart from the first body end. The body defines a cavity. The first body end defines an inlet port extending to the cavity, and the second body end defines an outlet port extending to the cavity. The diffuser insert has a diffuser longitudinal axis, a first diffuser end, and a second diffuser end opposite and spaced apart from the first diffuser end. The first diffuser end defines a diffuser central channel extending to the second diffuser end. The diffuser insert is disposed within the cavity such that the second diffuser end is adjacent the outlet port and the diffuser central channel is in fluid communication with the cavity and the outlet port. The ball has a ball outer surface. The ball outer surface defines a groove extending circumferentially along a center line at least partially around a circumference of the ball. The groove has a V-shaped profile in a plane perpendicular to the center line. A depth of the groove tapers along the centerline from a shallowest groove portion to a deepest groove portion. The ball is rotatably disposed within the cavity such that the ball is adjacent the first diffuser end and the inlet port.

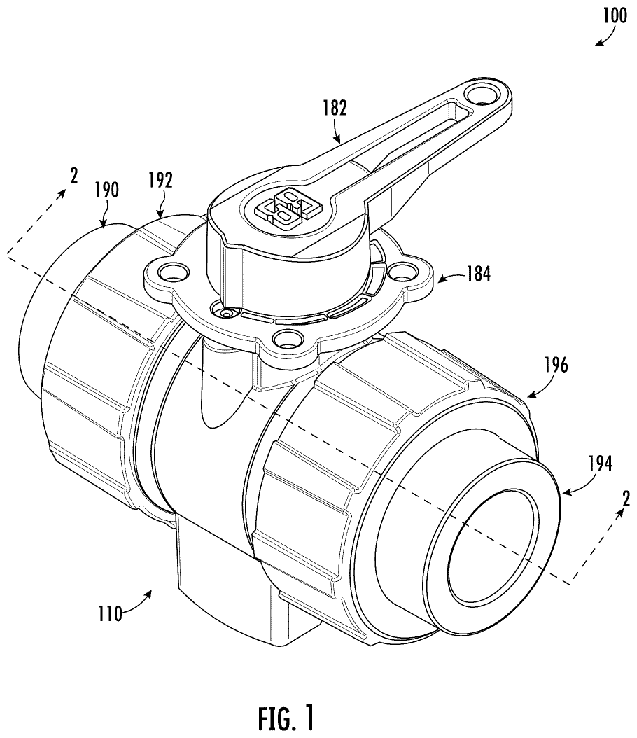

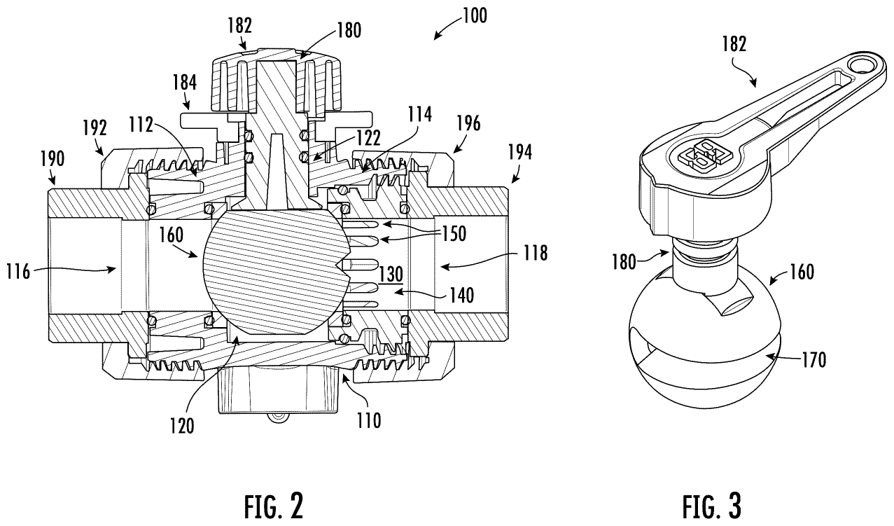

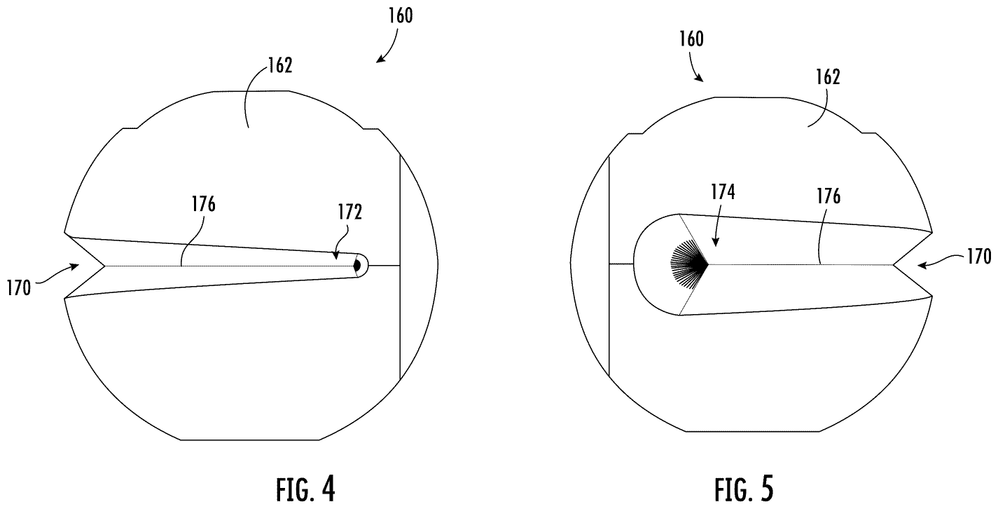

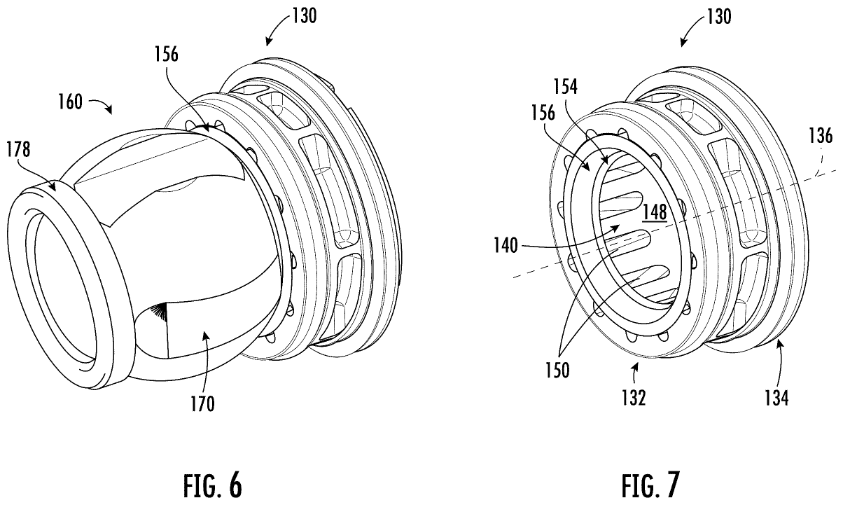

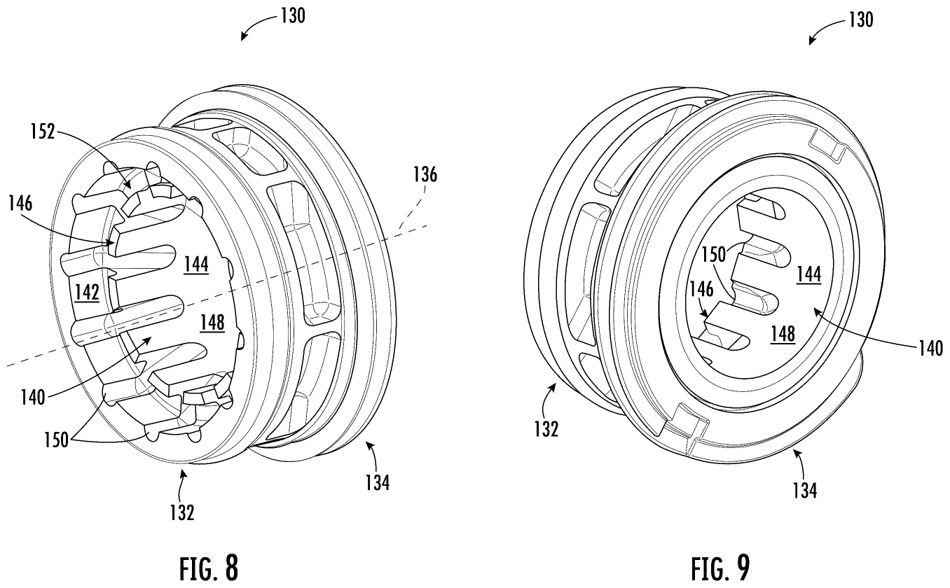

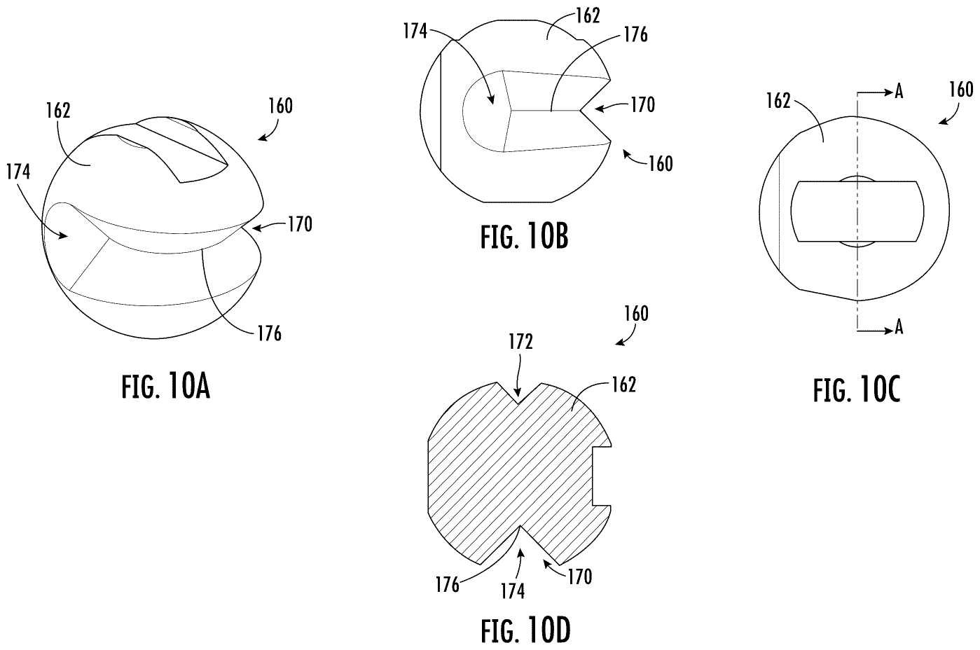

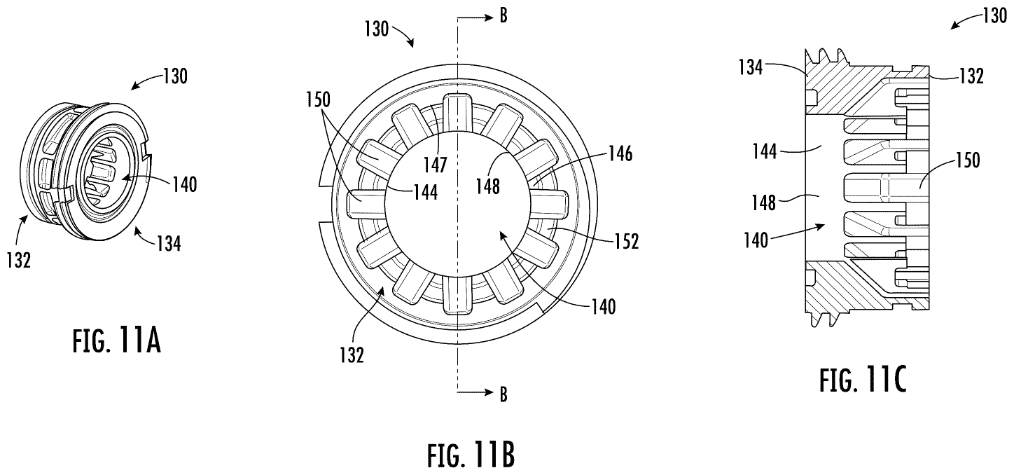

FIGS. 1-9 show a valve 100 according to aspects of various implementations. The valve includes a body 110, a diffuser insert 130, a diffuser seal 156, a ball 160, a valve stem 180, a handle 182, a dial gauge 184, a ball seal 158, an inlet coupler 190, an inlet hand nut 192, an outlet coupler 194, and an outlet hand nut 196.

The body 110 has a first body 112 end and a second body end 114 opposite and spaced apart from the first body end 112. The body 110 defines a cavity 120, an inlet port 116, an outlet port 118, and a stem opening 122. The first body end 112 defines the inlet port 116, and the second body 114 end defines the outlet port 118. The inlet port 116 extends from the first body end 112 to the cavity 120, and the outlet port 118 extends from the second body end 114 to the cavity 120. The stem opening 122 extends from an outer surface to the cavity 120.

The diffuser insert 130 has a diffuser longitudinal axis 136, a first diffuser end 132, and a second diffuser end 134 opposite and spaced apart from the first diffuser end 132. The first diffuser end 132 defines a diffuser central channel 140 extending to the second diffuser end 134.

The diffuser insert 130 is disposed within the cavity 120 of the body 110 such that the second diffuser end 134 is adjacent the outlet port 118 and the diffuser central channel 140 is in fluid communication with the cavity 120 and the outlet port 118.

The diffuser central channel 140 is defined by a diffuser inner surface 148. The diffuser inner surface 148 defines twelve longitudinally extending diffuser grooves 150. The diffuser grooves 150 extend from the first diffuser end 132 toward the second diffuser end 134. The depth and number of diffuser grooves 150 allow for higher flow rates of fluid through the diffuser central channel 140.

The diffuser central channel 140 includes a first portion 142 adjacent the first diffuser end 132 and a second portion 144 adjacent the second diffuser end 134. The first portion 142 has a first diameter, and the second portion 144 has a second diameter that is less than the first diameter. A seal shoulder 146 is defined where the first portion 142 and the second portion 144 meet, and each of the twelve diffuser grooves 150 extend from the first portion 142 into the second portion 144. The seal shoulder 146 defines a circumferentially extending diffuser seal groove 152 configured to receive an O-ring 154. The diffuser seal 156 is disposed within the first portion 142 of the diffuser central channel 140 such that it abuts the O-ring 154 disposed within the diffuser seal groove 152.

Although the diffuser insert 130 shown in FIGS. XX includes twelve diffuser grooves 150, in some implementations, the diffuser inner surface defines any number of one or more longitudinally extending diffuser grooves extending from the first diffuser end toward the second diffuser end.

The ball 160 has a ball outer surface 162. The ball outer surface 162 defines a groove 170 extending circumferentially along a center line 176 at least partially around a circumference of the ball 160. The groove 170 has a V-shaped profile in a plane perpendicular to the center line 176. The depth of the groove 170 tapers along the centerline 176 from a shallowest groove portion 172 to a deepest groove portion 174.

The ball 160 is rotatably disposed within the cavity 120 such that the ball 160 is seated within the first portion 142 of the diffuser central channel 140 and adjacent the inlet port 116. The ball 160 abuts the diffuser seal 156 disposed within the diffuser central channel 140. The ball seal 178 is disposed between the ball 160 and the inlet port 116 such that the ball 160 abuts the ball seal 178.

The valve stem 180 extends through the stem opening 122 of the body 110 and is coupled to the ball 160. The valve stem 180 is rotatable relative to the body 110 such that rotation of valve stem 180 causes the ball 160 to rotate. A handle 182 is coupled to the valve stem 180 such that a user can rotate the handle 182 to cause the ball 160 to rotate within the cavity 120 of the body 110. The dial gauge 184 is disposed against the body 110 and defines an opening though which the valve stem 180 extends. The dial gauge 184 includes a scale indicating the amounts of fluid flowing through the valve 100.

The ball 160 is rotatable between a first position, a second position, and a third position. In the first position, the inlet port 116 is not in fluid communication with the groove 170 of the ball 160 such that fluid is prevented from flowing from the inlet port 116, through the cavity 120, and through the outlet port 118. In the second position, the inlet port 116 is in fluid communication with the shallowest groove portion 172 such that fluid is allowed to flow from the inlet port 116, through the groove 170, and through the outlet port 118. In the third position, the inlet port 116 is in fluid communication with the deepest groove portion 174 such that a relatively higher flow rate of fluid than in the second position is allowed to flow from the inlet port 116, through the groove 170, and through the outlet port 118.

Although the valve 100 shown in FIGS. 1-9 includes a handle 182 for manually rotating the valve stem 180 and ball 160, in some implementations, the valve includes an actuator coupled to the valve stem for causing the valve stem to rotate. In some implementations, the handle is removable from the valve stem such that an actuator is couplable to the valve stem.

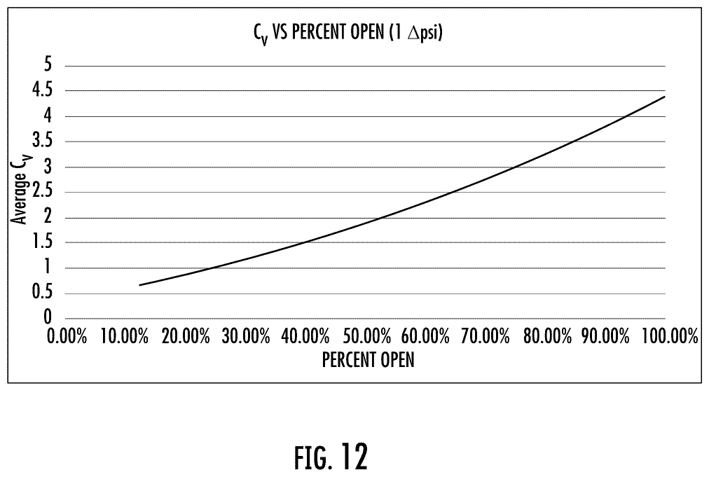

FIG. 12 shows an example Cv chart for the valve 100 shown in FIGS. 1-9. The Cv chart shows valve flow coefficient for the valve at different percentages of the valve being open.

The inlet coupler 190 is coupled to and is in fluid communication with the inlet port 116 of the body 110. The inlet coupler 190 is coupled to the body 110 by the inlet hand nut 192. The outlet coupler 194 is coupled to and is in fluid communication with the outlet port 118 of the body 110. The outlet coupler 194 is coupled to the body 110 by the outlet hand nut 196. The inlet coupler 190 and the outlet coupler 194 allow the valve 100 to be coupled to inlet and outlet conduits in a fluid stream. The inlet coupler 190 and the outlet coupler 194 have a 1-inch diameter, but in some implementations, the inlet coupler and the outlet coupler are any sized diameter.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

What is claimed is:

1. A valve comprising:
a body having a first body end and a second body end opposite and spaced apart from the first body end, wherein the body defines a cavity, wherein the first body end defines an inlet port extending to the cavity and the second body end defines an outlet port extending to the cavity;
a diffuser insert having a diffuser longitudinal axis, a first diffuser end, and a second diffuser end opposite and spaced apart from the first diffuser end, wherein the first diffuser end defines a diffuser central channel extending to the second diffuser end, wherein the diffuser insert is disposed within the cavity such that the second diffuser end is adjacent the outlet port and the diffuser central channel is in fluid communication with the cavity and the outlet port; and
a ball having a ball outer surface, wherein the ball outer surface defines a groove extending circumferentially along a center line at least partially around a circumference of the ball, wherein the groove has a V-shaped profile in a plane perpendicular to the center line, wherein a depth of the groove tapers along the centerline from a shallowest groove portion to a deepest groove portion, wherein the ball is rotatably disposed within the cavity such that the ball is adjacent the first diffuser end and the inlet port.

2. The valve of claim 1, wherein the ball is rotatable between a first position, a second position, and a third position, wherein:
the inlet port is not in fluid communication with the groove in the first position,
the inlet port is in fluid communication with the shallowest groove portion in the second position, and
the inlet port is in fluid communication with the deepest groove portion in the third position.

3. The valve of claim 1, wherein the diffuser central channel is defined by a diffuser inner surface, wherein the diffuser inner surface defines one or more longitudinally extending diffuser grooves extending from the first diffuser end toward the second diffuser end.

4. The valve of claim 3, wherein the first diffuser end defines a diffuser seal groove, wherein the valve further comprises a diffuser seal disposed in the diffuser seal groove, wherein the ball abuts the diffuser seal.

5. The valve of claim 1, further comprising a valve stem coupled to the ball and rotatable relative to the body, wherein rotation of valve stem causes the ball to rotate.

6. The valve of claim 5, further comprising a handle coupled to the valve stem for causing rotation of the valve stem.

7. The valve of claim 5, further comprising an actuator coupled to the valve stem for causing rotation of the valve stem.

8. The valve of claim 5, further comprising a dial gauge adjacent the valve stem, wherein the dial gauge includes a scale of amounts of fluid flowing through the valve.

9. The valve of claim 1, wherein the valve is a 1-inch valve.

10. The valve of claim 1, wherein the valve is a soft wash valve for metering bleach into a stream of water.
